(19) United States
(12) Patent Application Publication
(10) Pub. No.: US 2021/0123167 A1
(43) Pub. Date: Apr. 29, 2021

(54) HYBRID RAG

(71) Applicant: Yong Cheol HONG, Siheung-si (KR)

(72) Inventor: Yong Cheol HONG, Siheung-si (KR)

(21) Appl. No.: 16/707,645

(22) Filed: Dec. 9, 2019

(30) Foreign Application Priority Data
Oct. 28, 2019 (KR) 10-2019-0134560

(51) Int. Cl. D03D 1/00; B08B 1/00

(52) U.S. Cl. CPC D03D 1/00; B08B 1/006; D10B 2403/0111; D03D 2700/0177; D03D 2700/017

(57) ABSTRACT

Disclosed herein is a hybrid rag. The hybrid rag includes: removal parts made of microfibers, and configured to remove even foreign materials in scratches; control parts disposed between the removal parts, and configured to provide slips while suppressing the close contact of the removal parts with a surface; and a base part coupled such that the removal parts and the control parts are alternately and successively disposed, and configured to hold the removal parts and the control parts; wherein the removal parts are configured such that the ends of the microfibers thereof are divided and spread upward; and wherein the control parts are configured such that the microfibers thereof are each twisted in one twisted unit in such a manner that each of the microfibers thereof is separated from the base part, is spirally raised and lowered, and is then combined with the base part.

### CROSS-REFERENCE TO RELATED APPLICATION

This application claims the benefit of Korean Patent Application No. 10-201960134560 filed on Oct. 28, 2019, which is hereby incorporated by reference herein in its entirety.

### BACKGROUND

### 1. Technical Field

The present invention relates generally to a rag, and more specifically to a rag that is used to wipe liquid materials from the surface of a vehicle, an airplane, or a base substrate on which paint is applied.

### 2. Description of the Related Art

Rags are being used in many areas such as homes, service areas, etc.

Rags are mainly used to wipe liquid material from the surface of an object, or to wipe the surface of an object with liquid material. Accordingly, rags are mainly made of material that can absorb liquid material desirably.

Meanwhile, microfiber refers to yarns having a thickness of 0.1 to 1.0 deniers. In everyday life, microfiber having a thickness of 0.1 deniers is frequently used. Mainly, polyester and nylon are mixed together at a ratio of 7 to 3, thread is extracted, and the extracted thread is equally divided into eight parts. Microfiber is considerably thin and thus has the advantage of wiping fine dust from the surface of an object, so that it is used to clean advanced electronic products.

Microfiber has excellent water absorption capability because it has a large surface area per the same area due to its structure in which very thin fiber strands are densely arranged, and performs rapid water absorption because the spacing between fiber strands is very narrow and thus a capillary phenomenon occurs. Due to these advantages, microfiber has recently been used for various rag applications.

Microfiber rags are widely used to wipe the painted surfaces of vehicles and airplanes. Microfiber rags may be classified into two types microfiber rags: microfiber rags for removing moisture and microfiber rags for removing residual materials.

The structure of the microfiber rags for removing moisture and the structure of the microfiber rags for removing residual materials are different from each other.

Microfiber is considerably thin. Accordingly, in the case where fiber strands are separated from one another, when moisture is absorbed into the fiber strands, they stick to one another and are tangled with one another, and thus the structures of the fiber strands are damaged, thereby shortening the lifespan of microfiber rages. Furthermore, the fiber strands of the microfiber stick to the surfaces of objects, and thus a large amount of force is required when an operator pushes a microfiber rag, so that a problem arises in that the usability of the microfiber rag is poor. Accordingly, the microfiber rags for removing moisture have a structure in which dozens of strands are twisted into each thick strand and such thick strands are woven together. These microfiber rags prevent the thick strands from being tangled with one another while maintaining moisture absorption capability, and provide ease of use because they can slide smoothly along surfaces.

However, in order to remove residual moisture after wiping most of moisture, fiber strands need to enter into every corner and desirable surface contact is required, so that it is desirable to have a structure in which microfiber strands are separated from one another. In addition, when the surface of an object is painted like the surface of a vehicle or an airplane, considerably fine fibers are required to remove foreign materials caught in fine scratches on the painted surface. In particular, even when residual polish solvent and the like remaining after the polishing of a vehicle are removed, finer fiber strands are effective for the removal of the residual polish solvent. Accordingly, in this case, a microfiber rag in which fiber strands are separated from one another is desirable for use.

For the above reasons, an inconvenience arises in that when a vehicle is cleaned, both the two types of microfiber rags are required.

### RELATED ART DOCUMENT

[Patent Document]

(Patent document 1 Korean Patent Application Publication 10-2015-0074689

### SUMMARY

An object of the present invention is to provide a hybrid rag that is appropriate for both the purpose of removing a larger amount of moisture and the purpose of removing residual materials.

In order to accomplish the above object, the present invention provides a hybrid rag including: removal parts made of microfibers, and configured to remove even foreign materials caught in scratches on a surface via their fine fiber strands; control parts disposed between the removal parts, and configured to provide slips on the surface while suppressing the close contact of the removal parts with the surface when liquid components are wiped from the surface; and a base part coupled such that the removal parts and the control parts are alternately and successively disposed, and configured to hold the removal parts and the control parts: wherein the removal parts are configured such that the ends of the microfibers thereof are divided; and wherein the control parts are configured such that the microfibers thereof are each twisted in one twisted unit in such a manner that each of the microfibers thereof is separated from the base part, is spirally raised upward and is spirally lowered back downward at a certain height, and is then combined with the base part (in which case a direction in which the fiber protrudes from the base part is defined as an upward direction).

The base part may be configured such that fiber strands constituting the base part are successively arranged in a second direction orthogonal to a first direction on a plane to form open rings in a successive and alternate form in the first direction and its opposite direction on the plane, and the fiber strands of the base part may be woven in such a manner that each specific fiber strand enters into an adjacent ring formed by a fiber strand adjacent to the specific fiber in the first direction, exits from the adjacent ring and then enters into a ring adjacent to the former adjacent ring; and the control parts may be tied along with the base part on the same plane as the base part, and may be woven in such a manner that the specific fiber strand is separated from another specific fiber strand in each portion in which the other specific fiber strand passes through an adjacent ring, is spirally raised and lowered with raised and lowered portions twisted together, and is then combined with the other specific fiber strand.

The removal parts may be coupled to the base part on a same plane as the base part, and may be woven in such a manner that each specific fiber strand of the base part is separated from another specific fiber strand in each portion in which the other specific fiber strand passes through an adjacent ring, and is then raised straight with the end of a raised portion divided into fine microfibers and the fine microfibers separated from one another and spread upward.

The height from the top of the base part to the tops of the removal parts may be higher than the height from the top of the base part to the tops of the control parts.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a schematic view showing a hybrid rag according to an embodiment of the present invention;

FIG. 2 is a view illustrating the exaggerated detailed structure of a base part in the hybrid rag of FIG. 1;

FIG. 3 is a view illustrating the exaggerated detailed structure of removal parts in the hybrid rag of FIG. 1;

FIG. 4 is a view illustrating the exaggerated detailed structure of control parts in the hybrid rag of FIG. 1; and

FIG. 5 is an exaggerated schematic side view illustrating still another feature of the present invention.

### DETAILED DESCRIPTION

Embodiments of the above-described present invention will be described in detail with reference to the accompanying drawings. For brevity of description, redundant or substantially the same descriptions will be omitted or abridged as much as possible.

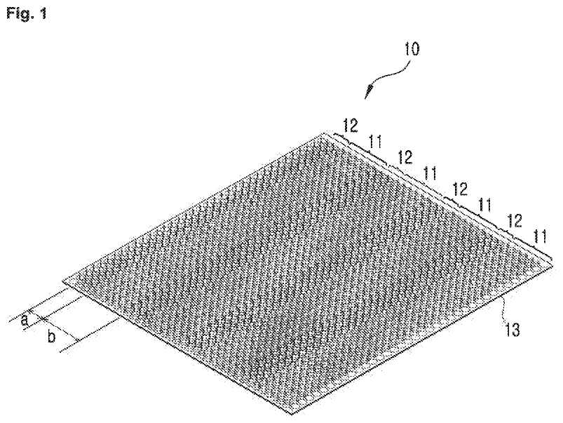

FIG. 1 is a schematic diagram showing a hybrid rag 10 according to an embodiment of the present invention.

The hybrid rag 10 according to the present embodiment includes removal parts 11, control parts 12, and a base part 13.

The removal parts 11 are spaced apart from each other at predetermined intervals, and are made of microfibers. These removal parts 11 are configured such that the fine fiber strands of microfibers are separated from one another and spread upward in order to remove even foreign materials in scratches on the surface of a painted vehicle or like.

The control parts 12 are disposed between the removal parts 11, suppress the close contact of the removal parts with the surface of an object (a vehicle, an airplane, or the like) when liquid components (e.g., moisture or liquid polish solvent residues) are wiped from the surface of the object, and generate slips between the hybrid rag 10 and the surface of the object.

The base part 13 is made of fibers different from the microfibers, is coupled such that the above-described removal parts 11 and control parts 12 are alternately and successively disposed, and functions to hold the removal parts 11 and the control parts 12.

Meanwhile, the removal parts 11 are configured such that the ends of microfibers thereof are separated from one another, whereas the control parts 12 are configured such that microfibers thereof are each twisted in one twisted unit.

In the control parts 12, the microfibers thereof are each twisted in one twisted unit in such a manner that each of the microfibers is separated from the base part 13, is spirally raised upward and lowered downward, and is then combined with the base part 13. In this case, a direction in which the fiber protrudes from the base part 13 is defined as an upward direction.

Next, the woven structures of the above-described removal parts 11 and control parts 12 will be described in detail.

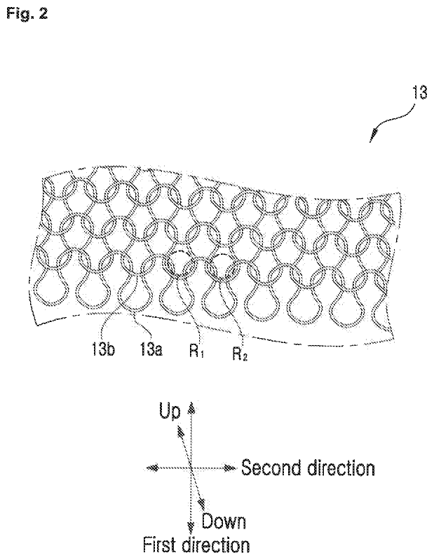

FIG. 2 is an exaggerated reference view illustrating the woven structure of the base part 13.

As shown in FIG. 2, in the base part 13, fiber strands constituting the base part 13 are successively arranged in a second direction orthogonal to a first direction on a plane to form open rings in a successive and alternate form in the first direction and its opposite direction on the plane. For this purpose, based on a specific fiber strand 13a, the specific fiber strand 13a and a fiber strand 13b adjacent to the specific fiber strand 13a in the first direction are woven in such a manner that the specific fiber strand 13a enters into an adjacent ring R1 formed by the adjacent fiber strand 13b, exits from the adjacent ring R1 and then enters into a ring R2 adjacent to the ring R1 in the second direction.

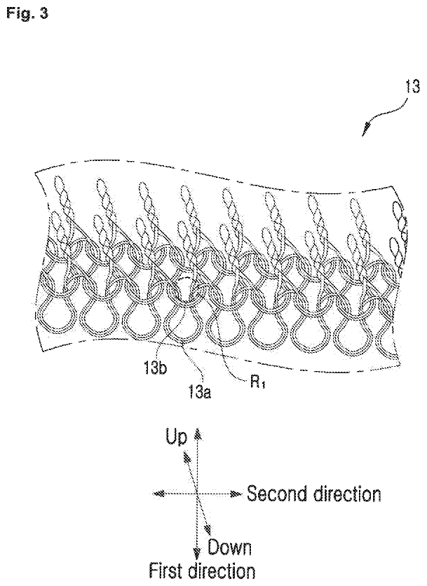

FIG. 3 is an exaggerated reference view illustrating the woven structure of the control parts 12.

As shown in FIG. 3, the control parts 12 are woven along with the base part 13 on the same plane as the base part 13, and are woven in such a manner that each specific fiber strand 13a is separated from another specific fiber strand 13a in each portion in which the other specific fiber strand 13a passes through an adjacent ring R1, is spirally raised and lowered with raised and lowered portions twisted together, and is then combined with the other specific fiber strand 13a. Accordingly, there is no concern about the occurrence of a defect in which the control parts 12 are separated from the base part 13.

Furthermore, in the control parts 12, the microfibers are each twisted to form one twisted unit in the form of a thick strand, and thus the force of the close contact of the control parts 12 with a surface is low and slips may be generated correspondingly. It will be apparent that the control parts 12 also have the function of absorbing liquid materials.

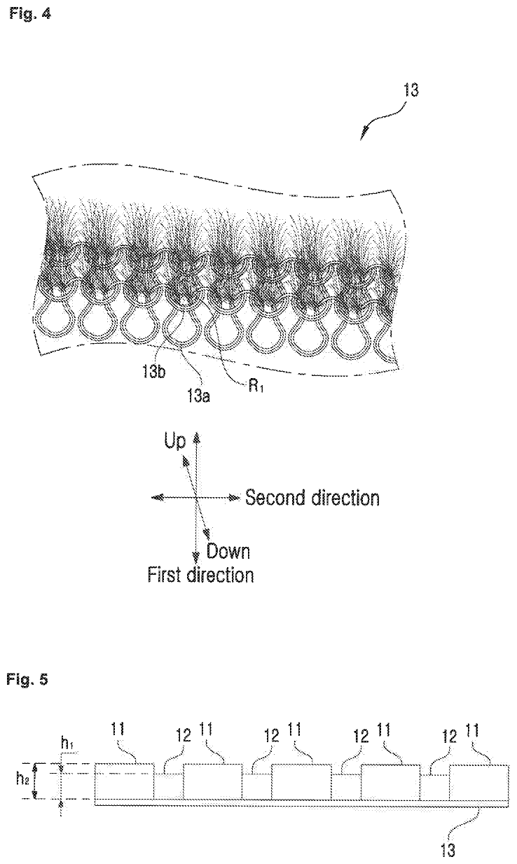

Meanwhile, FIG. 4 is an exaggerated reference view illustrating the woven structure of the removal parts 11.

Referring to FIG. 4, the removal parts 11 are coupled to the base part 13 on the same plane as the base part 13. However, each specific fiber strand 13a of the base part 13 is separated from another specific fiber strand 13a in each portion in which the other specific fiber strand 13a passes through the adjacent ring R1, and is then raised straight with an end of a raised portion divided into fine microfibers and the fine microfibers separated from one another and spread upward.

In other words, in the control parts 12, thick strands themselves each twisted in one twisted unit protrude from the base part 13, whereas, in the removal parts 11, spread fine strands protrude individually from the base part 13.

The above-described hybrid rag 10 functions to prevent the microfiber strands of the removal parts 11 from coming into excessive close contact with the surface of an object via the control parts 12 while applying the excellent absorption force and capacity of the removal parts 11. In other words, during a cleaning operation, the control parts 12 keep the base part 13 and the surface of an object spaced apart from each other at a predetermined interval. Furthermore, this also prevents the microfibers of the removal parts 11 from coming into excessive close contact with the surface of an object, being crushed, and being finally damaged.

It may be contemplated that a manufacturer adjusts the degree of slipping by manufacturing products in which the width of the control parts 12 has been adjusted according to a working situation and/or working characteristics.

Basically, it is preferable that the width of the control parts 12 be the same as that of the removal parts 11. However, if it is necessary to maximize the effect of moisture removal or the effect of residual moisture removal, it is more preferable that the width of the control parts 12 be smaller than that of the removal parts 11. It will be apparent that in the opposite case, the width of the control parts 12 may be larger than that of the removal parts 11. In other words, the widths of the control parts 12 and the removal parts 11 may be adjusted according to a working environment and/or the use of the hybrid rag during manufacture as much as it is required.

Meanwhile, the shapes of the twisted protrusions constituting the control parts 12 are maximally restored and maintained, and thus the control parts 12 have the function of holding the removal parts 11 on both sides of the removal parts 11, thereby further preventing the removal parts 12 from being damaged.

Next, FIG. 5 is an exaggerated schematic side view illustrating still another feature of the present invention.

As can be seen from FIG. 5, a height h₂ from the top of the base part 13 to the top of the removal parts 11 is higher than a height h₁ from the top of the base part 13 to the top of the control parts 12. This provides the following two functions.

First, as described above, due to the compression limit of the relatively strong control parts 12, it may be possible to considerably expand the surface area of the removal parts 11 having better ability to absorb moisture while minimizing the degree of close contact of the removal parts 11 with the surface of an object.

Second, the present function is derived when the first function is viewed from a different viewpoint. In other words, the removal parts 11 are higher than the control parts 1, so that the degree of close contact of the control parts 12, stronger than the removal parts 11, with the surface of an object may be reduced correspondingly, thereby preventing the control parts 12 from forming scratches on the surface of an object while sliding along the surface of the object.

According to the present invention, the following effects may be achieved.

First, a large amount of liquid material, residual liquid material and even foreign materials caught in scratches can be removed using a single rag, and thus the rag according to the present invention provides ease of use. In addition, even when the rag according to the present invention is used for a polishing purpose, the rag may remove all foreign materials, and thus a polishing effect may be maximized.

Second, moisture may be absorbed rapidly and a large amount of moisture may be absorbed by the removal portions and slips are generated by the control parts, and thus workability is improved. It will be apparent that a manufacturer may provide an optimum rag is appropriate to a site situation by adjusting the degree of slipping through the adjustment of the width of the control parts.

Third, the control portions hold the structure of the removal portions on both sides of the removal portions, and thus the lifespan of the rag is extended.

Fourth, the microfibers and the fibers constituting the base part are woven together, and thus the rag according to the present invention is structurally stable, thereby preventing the lifespan of the rag from being shortened due to a defect in which the microfibers are separated from the base part or the like.

Although the present invention has been specifically described using the embodiments taken with reference to the accompanying drawings, as described above, the above-described embodiments are described merely using preferred examples of the present invention. Accordingly, the present invention should not be interpreted as being limited only to the above-described embodiments, and the scope of the present invention should be interpreted as encompassing the following claims and ranges equivalent to the claims.

What is claimed is:

1. A hybrid rag comprising:
removal parts made of microfibers, and configured to remove even foreign materials caught in scratches on a surface via their fine fiber strands;
control parts disposed between the removal parts, and configured to provide slips on the surface while suppressing close contact of the removal parts with the surface when liquid components are wiped from the surface; and
a base part coupled such that the removal parts and the control parts are alternately and successively disposed, and configured to hold the removal parts and the control parts;
wherein the removal parts are configured such that ends of microfibers thereof are divided; and
wherein the control parts are configured such that microfibers thereof are each twisted in one twisted unit in such a manner that each of the microfibers thereof is separated from the base part, is spirally raised upward and is spirally lowered back downward at a certain height, and is then combined with the base part (in which case a direction in which the fiber protrudes from the base part is defined as an upward direction).

2. The hybrid rag of claim 1, wherein:
the base part is configured such that fiber strands constituting the base part are successively arranged in a second direction orthogonal to a first direction on a plane to form open rings in a successive and alternate form in the first direction and its opposite direction on the plane, and the fiber strands of the base part are woven in such a manner that each specific fiber strand enters into an adjacent ring formed by a fiber strand adjacent to the specific fiber in the first direction, exits from the adjacent ring and then enters into a ring adjacent to the former adjacent ring; and
the control parts are tied along with the base part on a same plane as the base part, and are woven in such a manner that the specific fiber strand is separated from another specific fiber strand in each portion in which the other specific fiber strand passes through an adjacent ring, is spirally raised and lowered back with raised and lowered portions twisted together, and is then combined with the other specific fiber strand.

3. The hybrid rag of claim 2, wherein the removal parts are coupled to the base part on a same plane as the base part, and are woven in such a manner that each specific fiber strand of the base part is separated from another specific fiber strand in each portion in which the other specific fiber strand passes through an adjacent ring, and is then raised straight with an end of a raised portion divided into fine microfibers and the fine microfibers separated from one another and spread upward.

4. The hybrid rag of claim 1, wherein a height from a top of the base part to tops of the removal parts is higher than a height from the top of the base part to tops of the control parts.
